(19) United States
(12) Patent Application Publication
(10) Pub. No.: US 2026/0326914 A1
(43) Pub. Date: Oct. 22, 2026

(54) IMPROVED PROPULSION ASSEMBLY FOR MULTI-ENGINE HYBRID AIRCRAFT

(71) Applicant: SAFRAN HELICOPTER ENGINES, Bordes (FR)

(72) Inventors: Romain Jean Gilbert THIRIET, Moissy-Cramayel (FR); Olivier BEDRINE, Moissy-Cramayel (FR)

(73) Assignee: SAFRAN HELICOPTER ENGINES, Bordes (FR)

(21) Appl. No.: 18/997,908

(22) PCT Filed: Jun. 22, 2023
(86) PCT No.: PCT/FR2023/050945

§ 371 Date: Jan. 23, 2025

(30) Foreign Application Priority Data
Jul. 27, 2022 (FR) FR2207741

(51) Int. Cl. B64D 35/025; B64C 27/14; B64D 27/33; F02C 6/02; F02C 7/268

(52) U.S. Cl. CPC B64D 35/025; B64C 27/14; B64D 27/33; F02C 6/02; F02C 7/268; F05D 2220/329

(57) ABSTRACT

A propulsion assembly for a hybrid aircraft including a first and a second engine each having a gas generator and a free turbine, a main rotor coupled to the free turbine, the engines each including a first electric machine and a second electric machine of lower power than the first electric machine, one of the electric machines being coupled to the gas generator to set in rotation the gas generator during a start phase, and being coupled to the free turbine after the start phase in order to generate electrical energy, the other of the electric machines being coupled to the gas generator only, at least one of the first or second electric machines of the first and/or second engines being able to transmit electrical energy to the other electric machine.

### TECHNICAL FIELD

The present invention relates to the field of hybrid aircrafts, comprising at least two engines such as turbine engines or turboprop engines, for flying vehicles such as helicopters or twin-engine airplanes. Particularly, the invention relates to a propulsion assembly for a multi-engine hybrid in particular twin-engine aircraft, a hybrid aircraft comprising such a propulsion assembly, and a method using such a propulsion assembly.

### PRIOR ART

In a known manner, a turbomachine, for example a turbine engine, in particular for a helicopter, includes a gas turbine having a gas generator and a free turbine driven in rotation by the gas stream generated by the gas generator.

Traditionally, the gas generator includes at least one compressor and one turbine coupled in rotation. The operating principle is as follows: the fresh air entering the gas turbine is compressed due to the rotation of the compressor before being sent to a combustion chamber where it is mixed with a fuel. The gases burnt due to the combustion are then discharged at high speed. A first expansion then occurs in the gas generator turbine, during which the latter extracts the energy necessary to drive the compressor. The turbine of the gas generator does not absorb all the kinetic energy of the burnt gases and the excess kinetic energy corresponds to the gas stream generated by the gas generator. The latter therefore provides kinetic energy to the free turbine so that a second expansion occurs in the free turbine which transforms this kinetic energy into mechanical energy in order to drive a receiving member, such as the rotor of the helicopter.

Some aircrafts include two turbomachines or more, each comprising a gas turbine as described above. This is in particular the case for twin-engine or multi-engine helicopters. Such aircrafts allow an operation in SEO (Single Engine Operative) mode. The SEO mode is an operating mode of a twin-engine architecture in which one of the gas turbines is voluntarily stopped, the other ensuring the entire power provision. This mode makes it possible to optimize the specific consumption, which decreases with the power provided by a turbomachine. Indeed, the specific consumption of a turbine decreasing with the power provided, it is indeed preferable to provide 100% of the power with one turbine, rather than 50% by each of them.

One of the critical points of the SEO mode lies in the ability to reignite the stopped turbine in case of power loss from the operating turbine. In order to ensure the fastest possible restart, it is possible to keep the stopped turbine in standby (or “super idle”) mode, that is to say continue to run its gas generator exclusively by means of an electric machine, without fuel supply. The generator is then kept in its “ignition window” (typically 10-30% of the nominal rotational speed of the gas generator) in order to allow immediate ignition of the fuel, namely in “super-idle” mode by means of a combustion at a low speed threshold and assisted by means of a mechanical power supply via an electric machine, in order to benefit from a combustion chamber already ignited but with a controlled internal temperature.

The twin-engine applications involve many functions, such as starting the gas generator, generating electricity on board, or providing mechanical power to the main rotor. Existing solutions for performing some of these functions are not entirely satisfactory. Particularly, they do not allow supplying the redundancy necessary to the function of starting the engine in standby mode, nor limiting the impact of the electrical draw from the engine when the helicopter is not operating in SEO mode. There is therefore a need for a twin-engine or multi-engine aircraft propulsion assembly having an architecture that meets at least partly the aforementioned drawbacks.

### DISCLOSURE OF THE INVENTION

The present disclosure relates to a propulsion assembly for a hybrid aircraft, in particular a multi-engine helicopter, comprising:
at least a first engine and a second engine each having a gas generator and a free turbine driven in rotation by a gas stream generated by the gas generator,
a main rotor coupled to the free turbine of the first engine and of the second engine,
the first engine and the second engine each comprising a first electric machine and a second electric machine of lower power than the first electric machine, one of the first or second electric machines being able to be coupled to the gas generator and to set in rotation the gas generator during a start phase of the engine, and being further able to be coupled to the free turbine after the engine start phase in order to generate electrical energy, the other of the first or second electric machines being coupled to the gas generator only, at least one of the first or second electric machines of the first engine and/or second engine being able to transmit electrical energy to the other of the first or second electric machines.

The main rotor may be coupled to the free turbine of the first engine and second engine via a first and a second main coupling means respectively. Moreover, the free turbine of each of the first and second engines may be in direct engagement with the main rotor, or via a mechanical reduction gear.

It is understood that according to the present disclosure, each of the first and second engines is equipped with a first electric machine and a second electric machine, preferably symmetrically. While one of the first or second electric machines is able to be coupled with the gas generator or with the free turbine depending on the operating phases, the other electric machine is coupled only to the gas generator. The first electric machine is furthermore dimensioned so as to be able to provide a higher power than the second electric machine, in particular for quick start phases. The first electric machine is therefore of high power, of the order of one or several hundred kilowatts, while the second electric machine is of low power, of the order of 10 kW, such as a generator/starter commonly used in aircraft engines.

According to this configuration, one of the first or second electric machines is able to be coupled to the free turbine after the start phase of the turbine engine in order to generate electrical energy. In other words, in flight, the free turbine advantageously drives in rotation said first or second electric machine, operating as an electric generator, such that the kinetic energy intended to be transformed into electrical energy is advantageously drawn from the free turbine, and not from the gas generator. This makes it possible to provide electricity while limiting the impact on the efficiency of the engine. As a result, the turbine engine according to the invention advantageously makes it possible to provide electricity without too much penalizing its efficiency.

In addition, during an operation in SEO mode, when the first (or second) engine drives the main rotor alone, the first (or second) electric machine driven by the free turbine and operating in generator mode can be used to supply electrical energy to the second (or first) electric machine coupled to the gas generator only, in order to assist the latter. At the same time, the first or second electric machine of the engine operating in standby mode can be used to keep the gas generator of this engine in rotation at low speed. The first high-power electric machine can also be used for a quick restart of the engine in standby mode, in particular in case of emergency. The first or second electric machine can also be used independently in order to carry out a normal restart, thus allowing redundancy.

In addition, it is possible to use the two electric machines in start mode at the same time in order to increase the power injected into the gas generator during the quick reactivation phase and therefore to reduce the reactivation time.

Consequently, the multi-engine architecture according to the present disclosure has the advantage of being simple by limiting the number of components and connections. Particularly, it makes it possible to improve the reliability of the start for the engine in standby mode as part of the SEO mode, and to optimize the engine performance by drawing via one of the electric machines from the free turbine after the start phase in conventional twin-engine operation, while performing internal hybridization by the transmission of electrical energy between the first and second electric machines. It is thus possible to rationalize and optimize the number of electric machines and the architecture of the propulsion assembly, while making it possible to perform a high number of functions, and by reducing the mass of the device.

In some embodiments, the first electric machine is coupled to a shaft of the free turbine via first deactivatable coupling means, and is coupled to a shaft of the gas generator via second deactivatable coupling means, the first and second deactivatable coupling means being configured so as not to be activated simultaneously.

By “deactivatable coupling means”, it is meant that the coupling means can be in an activated position in which the members connected to said coupling means are coupled, or in a deactivated position in which said members are decoupled, it being understood that by “member” it is meant the electric machines, the main rotor and the gas generator.

According to the invention, when the first coupling means are activated, the second coupling means are deactivated, that is to say the first electric machine is coupled to the free turbine while being decoupled from the gas generator, while conversely, when the second coupling means are activated, the first coupling means are deactivated, that is to say the first reversible electric machine is coupled to the gas generator while being decoupled from the free turbine. Without departing from the framework of the invention, it is also possible to provide an intermediate position in which the first and second coupling means are deactivated at the same time.

In accordance with the invention, the first electric machine is preferably reversible and operates as an electric motor when the second coupling means are activated, so as to drive in rotation the gas generator during the start phase of the engine. Correlatively, the first reversible electric machine operates as an electric generator when the first coupling means are activated, so as to produce electricity by drawing kinetic energy from the free turbine, and this after the engine start phase, that is to say essentially in flight. Due to the fact that the first and second coupling means cannot be activated simultaneously, the occurrence of the undesired situation in which the free turbine drives in rotation the gas generator is avoided.

It is understood that according to this embodiment, the second electric machine is coupled only to the gas generator. However, it will be noted that a configuration in which the second electric machine and the first electric machine are reversed is also possible.

In some embodiments, the first coupling means comprise a first free wheel, the second coupling means comprise a second free wheel, and the first and second free wheels are mounted in opposition.

One advantage of the free wheel is that it does not need to be electronically or mechanically controlled by an external operator. Such a free wheel is generally made up of a hub and of a peripheral ring rotatably mounted on the hub. The hub can drive in rotation the peripheral ring but not vice versa. Also, the hub can only drive the ring when the hub rotates in a predetermined direction, which will be called “direction of engagement”. Otherwise, the hub and the peripheral ring rotate freely relative to each other. In this case, the deactivatable coupling means are activated when the hub of the free wheel drives in rotation the peripheral ring and, conversely, the deactivatable coupling means are deactivated when the hub of the free wheel does not drive in rotation the peripheral ring.

By “mounted in opposition” it is meant that the first free wheel can transmit a rotational torque coming from the first electric machine, while the second free wheel can transmit a rotational torque to the first electric machine.

In some embodiments, the first coupling means comprise a first reduction gear having a first reduction coefficient, while the second coupling means comprise a second reduction gear having a second reduction coefficient, and the ratio of the first and second reduction coefficients is smaller than a limit value.

By “reduction gear” it is meant one or more reduction stages, for example including gear trains. Such reduction gears are known elsewhere. Since the gas generator and the free turbine generally rotate substantially faster than the first electric machine, the reduction gear makes it possible to adapt the rotational speed of the electric machine to the speeds of the gas generator and of the free turbine.

Preferably, the limit value is chosen such that the first and second free wheels are not engaged simultaneously. Preferably, this limit value is proportional to the ratio of the nominal speed of the gas generator to the nominal speed of the free turbine.

In some embodiments, when one of the first or second engines drives the main rotor alone, the gas generator of the other of the first or second engines is kept in a standby mode, via the first or second electric machine.

When the aircraft operates in SEO mode, the second engine, for example, ensures the entire power provision, while the first engine is voluntarily stopped, or preferably put in standby mode, in order to optimize the specific consumption. The standby mode makes it possible to keep the gas generator of the first engine in a range from 5 to 30% of its nominal rotational speed, in order to allow quick re-ignition if necessary, in particular when the second engine stops involuntarily.

In some embodiments, the second electric machine is coupled to the gas generator only, via a free wheel.

Consequently, the second electric machine can drive the gas generator during a start phase, but conversely, the gas generator cannot drive the second electric machine. Consequently, the second electric machine cannot provide electrical energy to the first electric machine either. According to this configuration, only the first electric machine can provide electrical energy to the second electric machine, in particular within the framework of assistance to the gas generator.

The present disclosure also relates to a hybrid aircraft comprising a propulsion assembly according to any one of the preceding embodiments, the hybrid aircraft being a multi-engine helicopter, in particular a twin-engine helicopter.

It is meant by “hybrid aircraft” an aircraft comprising a heat engine for driving in rotation a main rotor, and at least one electric machine for supplying power to the heat engine.

The present disclosure also relates to a method for optimizing the operation of a multi-engine aircraft using a propulsion assembly according to any of the preceding embodiments, in which, during a start phase of one of the first or second engines, the first electric machine and/or the second electric machine drive the gas generator of said first or second engine without driving the free turbine, and after the start phase, the free turbine of said first or second engine drives one of the first electric machine or second electric machine in order to generate electrical energy, the first electric machine or second electric machine generating electrical energy being able to transmit electrical energy to the other of the first or second electric machines coupled only to the gas generator.

In some embodiments, one of the first or second engines is able to operate alone, the other engine then operating in a standby mode while being driven at idle by the first or second electric machine, the engine operating in the standby mode being restarted by the first electric machine at least during a quick restart phase.

### BRIEF DESCRIPTION OF THE DRAWINGS

The invention and its advantages will be better understood upon reading the detailed description given below of different embodiments of the invention given as non-limiting examples. This description refers to the pages of the appended figures, in which:

FIG. 1 represents a sectional view of a propulsion assembly for a twin-engine aircraft according to the invention,

FIG. 2 represents a functional diagram of the propulsion assembly of FIG. 1 according to one embodiment.

### DESCRIPTION OF THE EMBODIMENTS

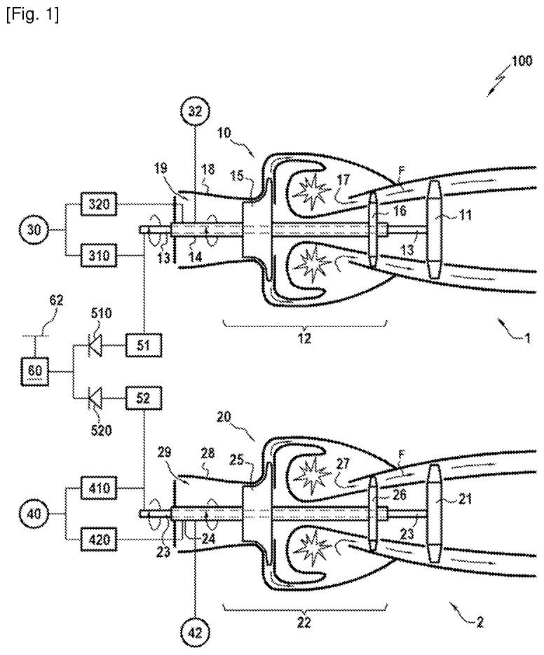

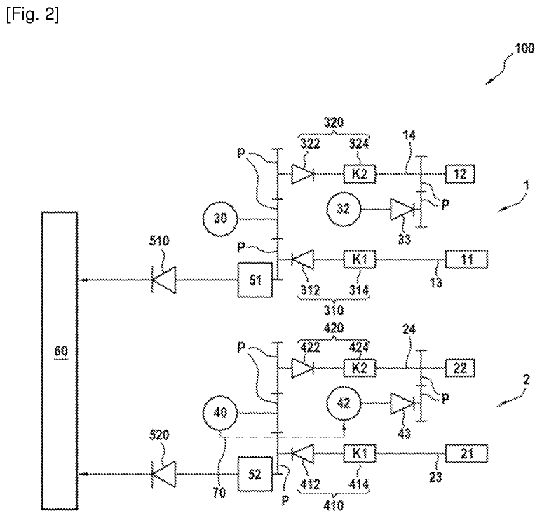

One architecture of a propulsion assembly 100 according to one embodiment of the invention will be described in the remainder of the description, with reference to FIGS. 1 and 2.

It will be generally noted that, for the sake of clarity, the figures schematically represent in a functional and simplified manner one architecture of the device, without representing all the details of the elements constituting the turbomachines and the various power transmission members. Particularly, the pinions P allowing the shafts 13, 14 to be driven by the electric machines, and vice versa where appropriate, are schematically represented, and any speed ratios are not represented.

FIG. 1 schematically represents a propulsion assembly 100 of a twin-engine aircraft, comprising a first engine, in this example a first turbomachine 1 and a second engine, in this example a second turbomachine 2, driving in rotation transmission members 60 of a helicopter carrying a propeller or a main rotor 62. The turbomachines can be turbine engines or turboprop engines. Although the propulsion assembly described in the remainder of the description comprises two turbomachines, this example is not limiting, the invention also applying to the propulsion assemblies of multi-engine aircrafts comprising more than two engines.

The first turbomachine 1 and the second turbomachine 2 are preferably identical and have the same characteristics. Also, the description below refers to both the first and second turbomachines 1, 2.

The first turbomachine 1 and the second turbomachine 2 respectively comprise a gas turbine 10, 20 having a gas generator 12, 22 and a free turbine 11, 21 able to be driven in rotation by a gas stream generated by the gas generator 12, 22. The free turbine 11, 21 is mounted on a shaft 13, 23 that transmits the rotational movement to a receiving member such as a main rotor 62 of the helicopter via the transmission members 60. According to this example, the gas turbine 10, 20 represented in FIG. 1 is of the front power take-off type with transmission by coaxial shaft. It could be very possible to consider, without departing from the framework of the present invention, a gas turbine with free turbine of the front power take-off type with transmission by inner or outer shaft, or a free turbine turbomachine of the rear power take-off type. In the same way, the turbine can be in direct engagement or integrate a speed reduction gear 51, 52 without calling into question the principle of the invention.

The gas generator 12, 22 includes a rotary shaft 14, 24 on which are mounted a compressor 15, 25 and a turbine 16, 26, as well as a combustion chamber 17, 27 disposed axially between the compressor 15, 25 and the turbine 16, 26 as long as the gas generator 12, 22 is considered along the axial direction of the rotary shaft 14, 24. The gas turbine 10, 20 has a casing 18, 28 provided with an air inlet 19, 29 through which the fresh air enters the gas generator 12, 22. After its intake into the enclosure of the gas generator 12, 22, the fresh air is compressed by the compressor 15, 25 which pushes it back towards the inlet of the combustion chamber 17, 27 in which it is mixed with fuel. The combustion taking place in the combustion chamber 17, 27 causes the burnt gases to be discharged at high speed towards the turbine 16, 26, which has the effect of driving in rotation the shaft 14, 24 of the gas generator 12, 22 and, consequently, the compressor 16, 26. The rotational speed of the shaft 14, 24 of the gas generator 12, 22 is determined by the fuel flow rate entering the combustion chamber 17, 27.

Despite the extraction of kinetic energy by the turbine 16, 26, the gas stream exiting the gas generator has significant kinetic energy. As understood from FIG. 1, the gas stream F is directed towards the free turbine 11, 21, which has the effect of causing an expansion in the free turbine 11, 21 leading to the rotation of the turbine wheel and of the shaft 13, 23.

The main rotor 62 is coupled, via the transmission members 60, to the shaft 13 of the free turbine 11 of the first gas turbine 10 by means of a first main coupling means 510 disposed between the speed reduction gear 51 and the transmission members 60. The main rotor 62 is also coupled, via the transmission members 60, to the shaft 23 of the free turbine 21 of the second gas turbine 20 by means of a second main coupling means 520 disposed between the speed reduction gear 52 and the transmission members 60.

Preferably, the first and second main coupling means 510, 520 comprise a free wheel mounted such that the rotation of the shaft 13, 23 can drive in rotation the main rotor 62 but such that, on the contrary, the rotation of the main rotor 62 cannot drive in rotation the shaft 13, 23 of the free turbine 11, 21. In other words, the free wheel of the first and second main coupling means 510, 520 can transfer a rotational torque only in the direction of the free turbine 11, 21 towards the main rotor 62, but not vice versa. On a helicopter, this free wheel is commonly called “engine free wheel”. It should be noted that the use of a free wheel for the main coupling means 510, 520 is not limiting, the free wheel being able to be replaced by any dog or clutch system.

The turbomachines 1, 2 further each include a first electric machine 30, 40, preferably reversible and comprising an electric motor able to operate reversibly as an electric generator. The first electric machine 30, 40 is mechanically coupled to the shaft 13, 23 of the free turbine 11, 21 via first deactivatable coupling means 310, 410.

The first deactivatable coupling means 310, 410 comprise a first free wheel 312, 412 and, preferably, a first speed adaptation reduction gear 314, 414 disposed between the free turbine 11, 21 and the first free wheel 312, 412.

The first free wheel 312, 412 is mounted such that the rotation of the free turbine 11, 21 can drive in rotation the first electric machine. 30, 40 then operating in generator mode, but such that on the contrary, the rotation of the first electric machine 30, 40 cannot drive the free turbine 11, 21. In other words, the free wheel 312, 412 of the first deactivatable coupling means 310, 410 can transfer a rotational torque only in the direction of the free turbine 11, 21 towards the first electric machine 30, 40.

The first electric machine 30, 40 is further mechanically coupled to the shaft 14, 24 of the gas generator 12, 22 by means of second deactivatable coupling means 320, 420.

The second deactivatable coupling means 320, 420 comprise a second free wheel 322, 422 and, preferably, a second speed adaptation reduction gear 324, 424 disposed between the gas generator 12, 22 and the second free wheel 322, 422.

The second free wheel 322, 422 is mounted such that the rotation of the first electric machine 30, 40, operating in motor mode, can drive in rotation the gas generator 12, 22, but such that, on the contrary, the rotation of the gas generator 12, 22 cannot drive the first electric machine 30, 40. In other words, the free wheel 322, 422 of the second deactivatable coupling means 320, 420 can transfer a rotational torque only in the direction of the first electric machine 30, 40 towards the gas generator 12, 22.

The first and second free wheels 312, 412 and 322, 422 are mounted in opposition. In this case, they have opposite directions of engagement. Thus, when the first reversible electric machine 30, 40 operates in motor mode to drive in rotation the shaft 14, 24 of the gas generator 12, 22 (second free wheel 322, 422 engaged, i.e. second coupling means 320, 420 activated), the first free wheel 312, 412 does not transmit the rotational torque of the first electric machine 30, 40 towards the shaft 13, 23 of the free turbine 11, 21 (first coupling means 310, 410 deactivated). Conversely, when the shaft 13, 23 of the free turbine 11, 21 drives in rotation the first electric machine 30, 40 operating as an electric generator (first free wheel 312, 412 engaged, i.e. first coupling means 310, 410 activated), the second free wheel 322, 422 does not transmit the rotational torque of the first electric machine 30, 40 towards the shaft 14, 24 of the gas generator 12, 22 (second coupling means 320, 420 deactivated).

The first speed adaptation reduction gear 314, 414 has a first reduction coefficient K1 preferably chosen such that the speed of the first electric machine 30, 40 is adapted to the speed range required to allow the provision of electricity. The second speed adaptation reduction gear 324, 424 has a second reduction coefficient K2 preferably chosen such that the speed of the first electric machine 30, 40 is adapted to the speed range required for starting the gas generator 12, 22.

To prevent the free turbine 11, 21 from driving in rotation the shaft 14, 24 of the gas generator 12, 22, the second free wheel 322, 422 must not be engaged. To do so, the reduction coefficients K1, K2 of the first reduction gear 314, 414 and of the second reduction gear 324, 424 are chosen appropriately. For example, but not necessarily, the reduction coefficients K1, K2 follow the ratios described in document FR2929324.

The turbomachines 1, 2 also each comprise a second electric machine 32, 42 mechanically coupled to the shaft 14, 24 of the gas generator 12, 22 only, preferably via a third free wheel 33, 43 allowing the second electric machine 32, 42 not to be driven by the gas generator when it is not used.

In this example, while the first electric machine 30, 40 is a high-power electric machine, in particular of several hundred kilowatts, the second electric machine 32, 42 may be a starter commonly used, with a power of the order of 10 kW. It will however be noted that this configuration is not limiting, the first and second electric machines being able to be reversed without departing from the framework of the invention.

This architecture of the propulsion assembly 100 allows different operating modes described in the remainder of the description, and makes it possible to optimize the operation of the propulsion assembly 100.

The presence of the two turbomachines 1, 2 allows an operation in SEO (Single Engine Operative) mode, in which only the second turbomachine 2 (for example) is in operation, ensuring the entire power provision to the main rotor 62, the first turbomachine 1 being voluntarily stopped. When the SEO mode is engaged, the gas generator 12 is put on standby (or in assisted super-idle), that is to say it no longer provides power. On the other hand, to be started as quickly as possible, the gas generator 12 is driven in the ignition window (in a range from 5 to 30% of its nominal rotational speed) by the first electric machine 30 or by the second electric machine 32.

From this operation in SEO mode, it is possible to restart the first turbomachine 1 within the framework of a normal restart, that is to say in a non-emergency situation requiring a quick restart, by optimizing the operation of the aircraft. Such an optimization method comprises, firstly, during the start phase of the first turbomachine 1, the fact of driving the gas generator 12 by the first electric machine 30 and/or the second electric machine 32, without driving the free turbine 11. Indeed, given the presence of the first free wheel 312, mounted in opposition to the second free wheel 322, the first electric machine 30 cannot drive in rotation the free turbine 11. Moreover, the second electric machine 32 is coupled to the gas generator 12 only, and therefore cannot drive the free turbine 11.

The first and second electric machines 30, 32 can be piloted by a monitoring unit (not represented). Thus, the first and/or the second electric machine 30, 32 drive the gas generator 12 via the free wheels 322, 33 respectively, allowing the start of the gas generator 12. Upon start of the gas generator 12, the hot gases drive the free turbine 11, the latter being connected to the main rotor 62 via the first free wheel 312, the speed reduction gear 51 and the free wheel of the first main coupling means 510.

In a second step, after the start phase, the free turbine 11 drives the first electric machine 30 via the first free wheel 312 in order to generate electrical energy. The first electric machine 30 can be electrically connected to an electric network of the propulsion assembly 100 in order to supply different electrical equipment (not represented). It will be noted that the steps above also apply to a normal start (and not a restart from the SEO mode) of either of the turbomachines 1 and 2, and in a non-emergency situation.

Furthermore, after the start phase and when the two gas generators 12, 22 are in operation (for example after the re-ignition of one of the two turbomachines to exit the SEO mode), the first electric machine 30, 40 generating electrical energy can transmit electrical energy to the second electric machine 32, 42 coupled only to the gas generator 12, 22, via an electrical connection 70, in order to carry out internal hybridization and assist the gas generator 12, 22 via the second electric machine 32, 42 engaged with the shaft 14, 24 of the gas generator 12, 22.

It will be noted that in the example illustrated in FIG. 2, only the second turbomachine 2 is equipped with an electrical connection 70. This allows the first electric machine 40 to assist the gas generator 22 via the second electric machine 42 engaged with the shaft 24 of the gas generator 22, in the SEO mode and when the second turbomachine 2 alone drives the main rotor 62.

This example is however not limiting, either or both of the turbomachines 1, 2 may be equipped with such an electrical connection 70. Furthermore, in this example, given the presence of the third free wheel 33, 43, the second electric machine 32, 42 cannot be driven to operate in generator mode, and consequently only the first electric machine 30, 40 can transfer electrical energy to the second electric machine 32, 42, but not vice versa. However, in the absence of the third free wheel 33, 43, the first 30, 40 and second 32, 42 electric machines could exchange electrical energy mutually, without departing from the framework of the invention.

Moreover, it is also possible to perform a quick restart of the first turbomachine 1 from the standby mode. This quick restart is identical to the start or restart step described above, but the first high-power electric machine 30 is necessarily used in this case, alone or possibly complemented by the second electric machine 32 in order to optimize the reactivation time. Indeed, the power of the first electric machine 30 being of the order of several tens to a few hundred kilowatts, it is possible to start the gas generator 12 much more quickly than with a starter with a power of the order of 10 kW, commonly used. This provides in particular an operational advantage in the case of medical rescue type missions, or during attempts at quick restart in flight.

Although the present invention has been described with reference to specific exemplary embodiments, it is obvious that modifications and changes may be made to these examples without departing from the general scope of the invention as defined by the claims. Particularly, individual characteristics of the various illustrated/mentioned embodiments may be combined in additional embodiments. Consequently, the description and drawings should be considered in an illustrative rather than a restrictive sense.

It is also obvious that all the characteristics described with reference to one method are transposable, alone or in combination, to one device, and conversely, all the characteristics described with reference to one device are transposable, alone or in combination, to one method.

1. A propulsion assembly for a hybrid aircraft, in particular a multi-engine helicopter, comprising:
at least a first engine and a second engine each having a gas generator and a free turbine driven in rotation by a gas stream generated by the gas generator,
a main rotor coupled to the free turbine of the first and second engines,
the first and second engines each comprising a first electric machine. and a second electric machine of lower power than the first electric machine, one of the first or second electric machines being able to be coupled to the gas generator and to set in rotation the gas generator during a start phase of the engine, and being further able to be coupled to the free turbine after the start phase in order to generate electrical energy, the other of the first or second electric machines being coupled to the gas generator only, at least one of the first or second electric machines of the first engine and/or second engine being able to transmit electrical energy to the other of the first or second electric machines.

2. The propulsion assembly according to claim 1, wherein the first electric machine is coupled to a shaft of the free turbine via first deactivatable coupling means, and is coupled to a shaft of the gas generator via second deactivatable coupling means the first and second deactivatable coupling means being configured so as not to be activated simultaneously.

3. The propulsion assembly according to claim 2, wherein the first deactivatable coupling means comprise a first free wheel the second deactivatable coupling means comprise a second free wheel, and the first and second free wheels are mounted in opposition.

4. The propulsion assemblyaccording to claim 2, wherein the first deactivatable coupling means comprise a first reduction gear having a first reduction coefficient, while the second deactivatable coupling means comprise a second reduction gear having a second reduction coefficient, and the ratio of the first and second reduction coefficients is smaller than a first limit value.

5. The propulsion assembly according to claim 1, wherein, when one of the first or second engines alone drives the main rotor, the gas generator of the other of the first or second engines is kept in a standby mode, via the first or second electric machine.

6. The propulsion assembly according to claim 1, wherein the second electric machine is coupled to the gas generator only, via a free wheel.

7. A hybrid aircraft comprising a propulsion assembly according to claim 1, the hybrid aircraft being a multi-engine helicopter, in particular a twin-engine helicopter.

8. A method for optimizing the operation of a multi-engine aircraft using a propulsion assembly according to claim 1, wherein, during a start phase of one of the first or second engines, the first electric machine and/or the second electric machine drive the gas generator of said first or second engine without driving the free turbine, and after the start phase, the free turbine of said first or second engine drives one of the first electric machine or second electric machine in order to generate electrical energy, the first electric machine or second electric machine generating electrical energy being able to transmit electrical energy to the other of the first or second electric machines coupled only to the gas generator.

9. The method according to claim 8, wherein one of the first or second engines is able to operate alone, the other engine then operating in a standby mode while being driven at idle by the first or second electric machine, the engine operating in the standby mode being restarted by the first electric machine at least during a quick restart phase.
